(19) United States
(12) Patent Application Publication
(10) Pub. No.: US 2010/0253628 A1
(43) Pub. Date: Oct. 7, 2010

(54) ONE FINGER CONTROLLED COMPUTER MOUSE

(75) Inventors: DOUG JACKE, Palm Harbor, FL (US); Matthew Graham, Indianapolis, IN (US)

Correspondence Address: TAFT STETTINIUS & HOLLISTER LLP, ONE INDIANA SQUARE, SUITE 3500, INDIANAPOLIS, IN, 46204-2023, US

(73) Assignee: SNAP DESIGN, LLC, Palm Harbor, FL (US)

(21) Appl. No.: 12/753,393

(22) Filed: Apr. 2, 2010

Related U.S. Application Data
(60) Provisional application No. 61/166,655, filed on Apr. 3, 2009.

(51) Int. Cl. G06F 3/033; G09G 5/08

(52) U.S. Cl. 345/163; 345/157

(57) ABSTRACT

A point and click computer device includes first and second pushbutton switches. An elongate rocker arm has first and second opposite ends. A housing contains the switches and includes a support supporting a mid-section of the rocker arm between the ends. The rocker arm is pivotable about the support between a first position in which the first end depresses the first pushbutton switch, a second position in which the second end depresses the second pushbutton switch, and an unbiased position in which neither of the switches is depressed.

The present application claims priority from U.S. provisional patent application Ser. No. 61/166,655 filed on Apr. 3, 2009, entitled “One Finger Controlled Computer Mouse,” which is hereby incorporated by reference in its entirety.

### FIELD OF THE INVENTION

The present invention relates to a point and click computer device, commonly referred to as a “computer mouse.”

### SUMMARY OF THE INVENTION

The present invention is directed to a computer mouse that may be used with just one finger of a user's left or right hand. Traditional right and left click functions may be performed by use of a rocker arm that is aligned with the user's finger. A stretchable fabric “hood” or “cap” may securely but releasably retain the user's finger in engagement with the rocker arm. The tightness with which the hood holds the finger against the rocker arm is adjustable. Thus, the operator can easily slide the mouse on and off the finger in order to type on the computer keypad. Once the user is done with typing, the finger can be easily reinserted under the hood for further use of the mouse.

The right and left click functions may be implemented by rolling the finger forwards and backwards on the rocker arm. The rocker arm may be imbedded in the chassis of the device.

In one embodiment, the invention includes a point and click computer device including first and second pushbutton switches. An elongate rocker arm has first and second opposite ends. A housing contains the switches and includes a support supporting a mid-section of the rocker arm between the ends. The rocker arm is pivotable about the support between a first position in which the first end depresses the first pushbutton switch, a second position in which the second end depresses the second pushbutton switch, and an unbiased position in which neither of the switches is depressed.

In another embodiment, the invention includes a computer mouse having first and second switches. An elongate rocker arm has first and second opposite ends. A housing contains the switches and includes a support that supports a mid-section of the rocker arm between the ends. The rocker arm is pivotable about the support between a first position in which the first end actuates the first switch, a second position in which the second end actuates the second switch, and an unbiased position in which neither of the switches is actuated. An arch-shaped elastic element has a first end attached to the rocker arm or to the housing. The elastic element straddles at least a majority of the rocker arm. The elastic element and the rocker arm define therebetween an opening sized to snugly receive a user's finger.

A computer mouse includes first and second switches. An elongate rocker arm has first and second opposite ends. A housing includes a support that supports the rocker arm between the ends. The rocker arm is pivotable about the support between a first position in which the first end actuates the first switch, a second position in which the second end actuates the second switch, and an unbiased position in which neither of the switches is actuated. At least one adjustment arm has an end pivotably attached to the housing. The adjustment arm has a body attachable to the housing at each of a plurality of attachment positions. An arch-shaped elastic element has an end attached to the body of the adjustment arm such that a size of an opening defined between the elastic element and the rocker arm may be adjusted by moving the body of the adjustment arm between the attachment positions.

An advantage of the present invention is that the rocker arm enables one finger to perform both a “right” and a “left” click.

Another advantage is that the device follows the natural arch and contour of the male and female human finger for hours of stress-free use.

Yet another advantage is that the hood is made of a flexible and comfortable material that adjusts to a wide variety of finger sizes. Thus, the hood both secures and easily releases the finger as the user desires.

Still another advantage is that the compactness of the mouse enables it to be used in tight spaces such as the table top of an airplane or the table in a coffee shop or restaurant.

A further advantage is the mouse incorporates Bluetooth and laser technology so that the mouse can be used out of sight and on a separate surface from that of the computer such as, for example, the operator's knee.

A still further advantage is that the hood enables one finger to control the device including movement of the mouse (pointing) and pivoting the rocker arm (clicking) without the need of a second or third finger, or palm of the hand, to grasp and hold the mouse.

A further yet advantage is that the hood also serves as a canvas upon which graphics representing brands or other commercial entities can be displayed or advertised. The hood may be attached to the mouse in such a way as to be easily removed and replaced with another hood. Thus, the user may freely switch hoods with their associated graphics as desired.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art.

Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

### BRIEF DESCRIPTION OF THE DRAWINGS

The invention may be performed in various ways, and, by way of example only, embodiments thereof will now be described, reference being made to the accompanying drawings in which:

FIG. 1 is a perspective view of one embodiment of a computer mouse of the present invention.

FIG. 2 is an exploded view of the computer mouse of FIG. 1.

FIG. 3 is a side view of the computer mouse of FIG. 1 with the adjustable hood assembly removed.

FIG. 4 is a side view of the computer mouse of FIG. 1 with the hood removed and the adjustment arm in the highest position.

FIG. 5 is a side view of the computer mouse of FIG. 1 with the hood removed and the adjustment arm in the middle position.

FIG. 6 is a side view of the computer mouse of FIG. 1 with the hood removed and the adjustment arm in the lowest position.

FIG. 7 is a bottom perspective view of the computer mouse of FIG. 1 with the retaining clip removed.

FIG. 8 is a bottom view of the computer mouse of FIG. 1.

FIG. 9 is perspective view of the computer mouse of FIG. 1 with the retaining clip removed.

FIG. 10 is a side perspective view of the mouse of FIG. 1 with the hood removed and the rocker arm in an unbiased position.

FIG. 11 is a side perspective view of the mouse of FIG. 1 with the hood removed and the rocker arm in a forward biased position.

FIG. 12 is a side perspective view of the mouse of FIG. 1 with the hood removed and the rocker arm in a backward biased position.

### DETAILED DESCRIPTION OF THE DRAWINGS

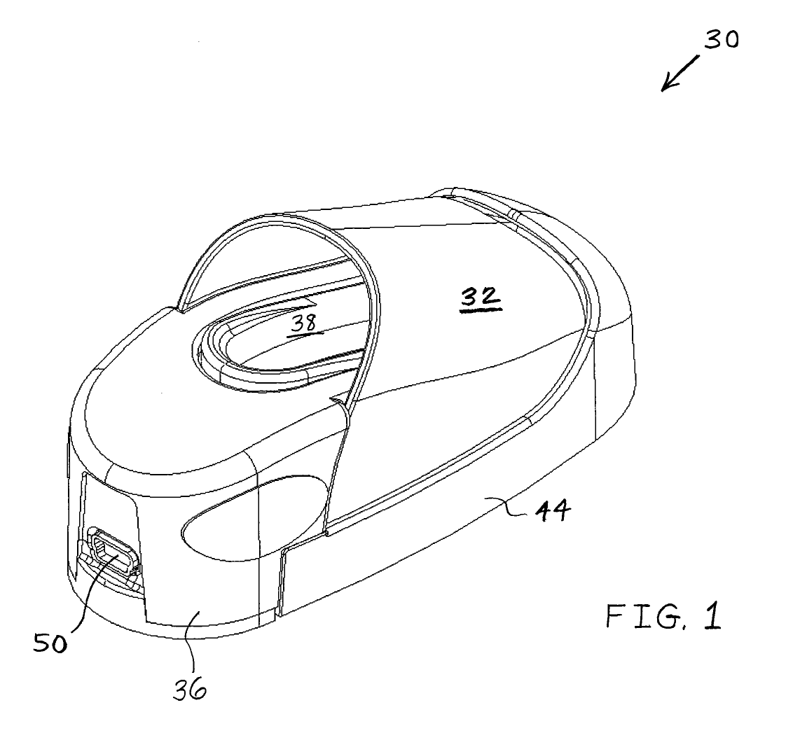

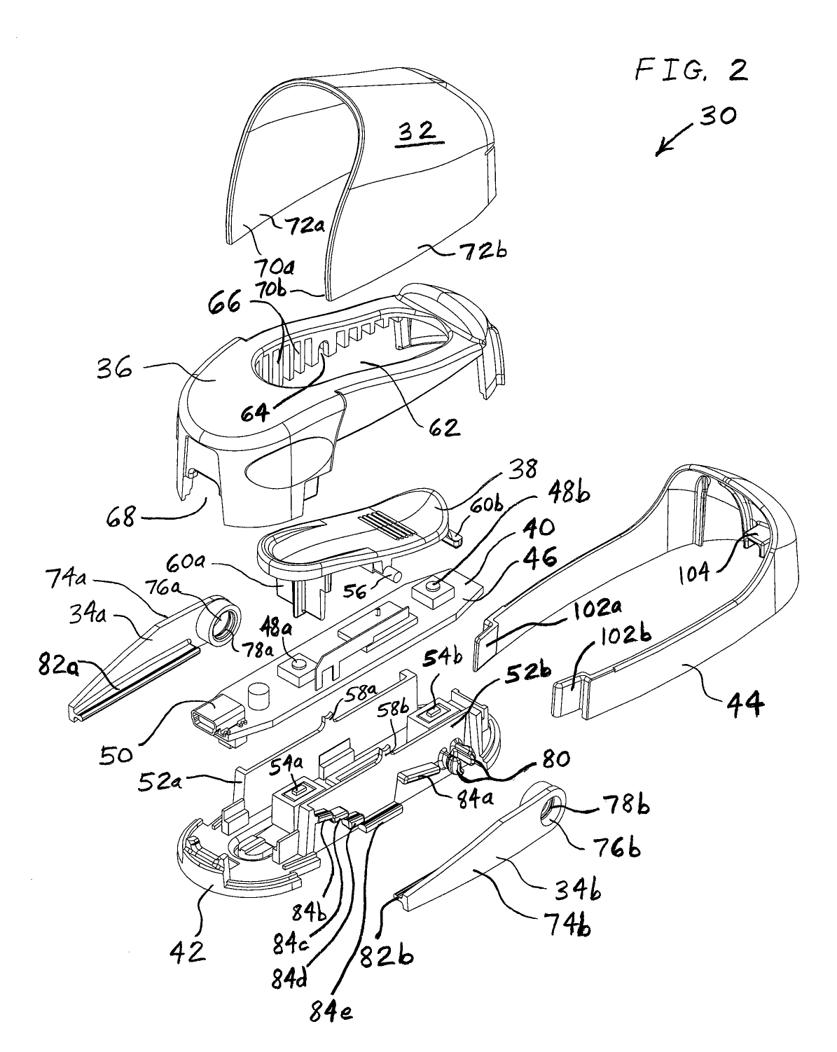

Referring to FIG. 1, one embodiment of a computer mouse 30 of the present invention is shown in its assembled form. As most easily seen in the exploded view of FIG. 2, mouse 30 includes an adjustable hood assembly having an arch-shaped elastic element in the form of a stretchable fabric hood 32 and adjustment arms 34a-b. Mouse 30 also includes a body 36, a rocker arm 38, a circuit board assembly 40, a base 42, and a retaining clip 44. Body 36 and base 42 conjointly form a housing of mouse 30.

Circuit board assembly 40 includes a circuit board 46 carrying a variety of electronic components, including pushbutton switches 48a-b, an LED indicator light 50, and a battery (not shown). Assembly 40 may be inserted between upstanding walls 52a-b of base 42 such that switches 48a-b each rests on a respective one of vertical supports 54a-b.

A mid-section of rocker arm 38 includes an axle 56 having opposite ends each resting on a respective support in the form of bosses 58a-b atop respective walls 52a-b. Rocker arm 38 includes two legs 60a-b positioned above respective pushbutton switches 48a-b.

Body 36 includes a through hole 62 through which rocker arm 38 partially passes. Body 36 includes opposing recesses 64 (only one of which is visible in FIG. 2) that receive the respective opposite ends of axle 56 and clamp, or at least retain, the opposite ends against bosses 58a-b. To this end, body 36 and base 42 may have mating snap connectors (not shown) that hold body 36 and base 42 together, and rocker arm 38 and circuit board assembly 40 therebetween. Body 36 includes ribs 66 that conjointly form a grate for blocking the ingress of debris into the cavity defined between body 36 and base 42. Body 36 also includes a notch 68 through which LED 50 is visible, as shown in FIG. 1.

Hood 32 may be formed of an elastic, stretchable fabric material. Although hood 32 is described herein as being arched-shaped when attached to mouse 30, it is to be understood that it may be possible to lay the sheet material of hood 32 out flat when the fabric is unattached to any other portion of mouse 30.

Inner surfaces 70a-b of opposite ends 72a-b of hood 32 may be affixed and/or adhered to respective outer surfaces 74a-b of respective adjustment arms 34a-b. Outer surfaces 74a-b of respective adjustment arms 34a-b may be textured in order to facilitate adhesion and/or may include sharp projections for piercing hood 32.

An end of each of arms 34a-b is pivotably attached to base 42. More particularly, an end of each of arms 34a-b includes a respective through hole 76a-b with an inner annular shoulder 78a-b for capturing a pair of male snap-on projections 80 extending perpendicularly from walls 52a-b. Thus, hood 32 may be attached to base 42 via arms 34a-b.

Adjustment arms 34a-b and the housing may have mateable snap-fit connectors. More particularly, projecting perpendicularly from inner surfaces of adjustment arms 34a-b are elongate latches 82a-b having T-shaped cross sections. Projecting perpendicularly from outer surfaces of walls 52a-b are elongate dogs 84a-e having L-shaped cross sections, with the exception of dog 84d, which has a T-shaped cross section. Only dogs 84a-e projecting from wall 52b are visible in the drawings.

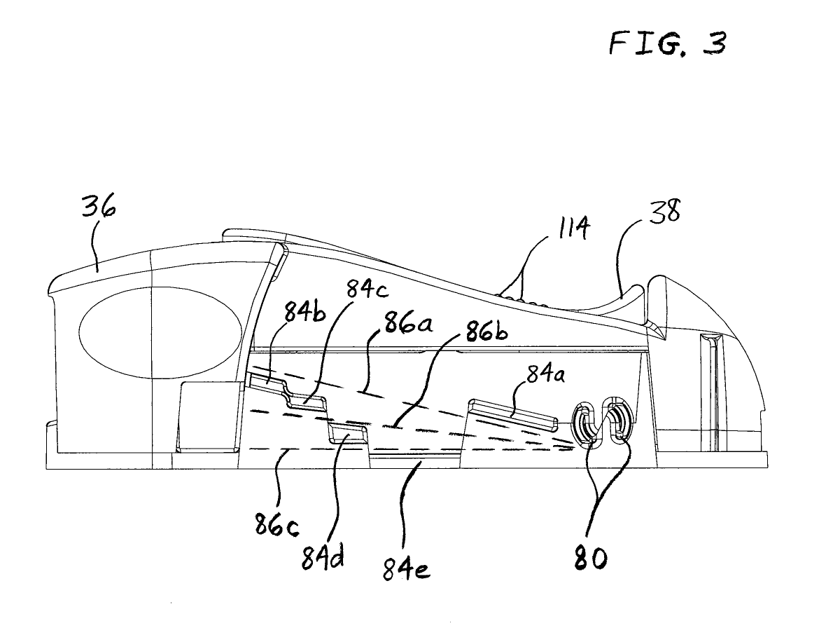

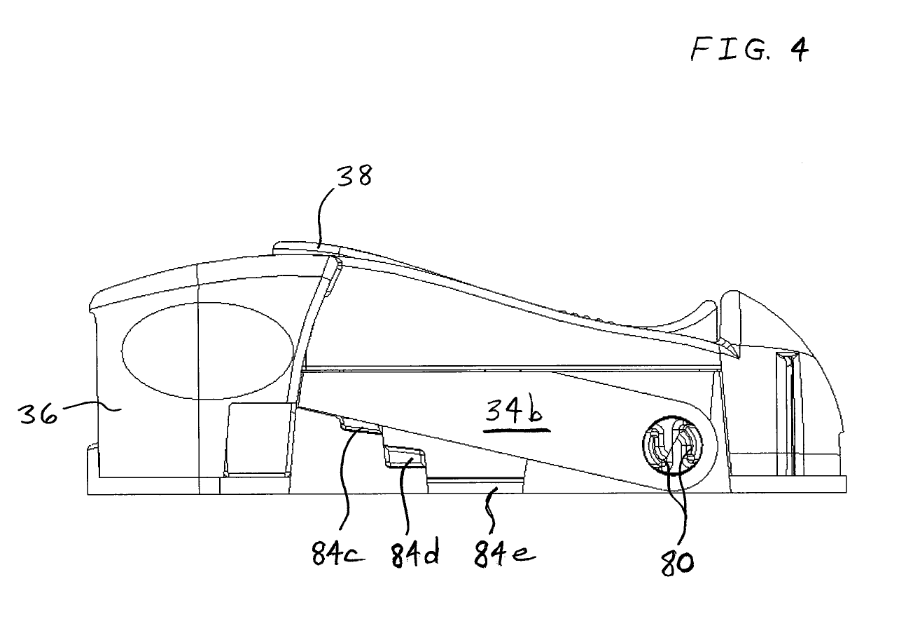

Adjustment arm 34b may be pivotable about projections 80 into three distinct and discrete positions. In the first position, latch 82b is received between and latched onto dogs 84a-b, as indicated schematically by dashed line 86a in FIG. 3. In this first position, hood 32 is in its highest position, and hood 32 may be loosest around the user's finger. Adjustment arm 34b is shown in this highest position in FIG. 4.

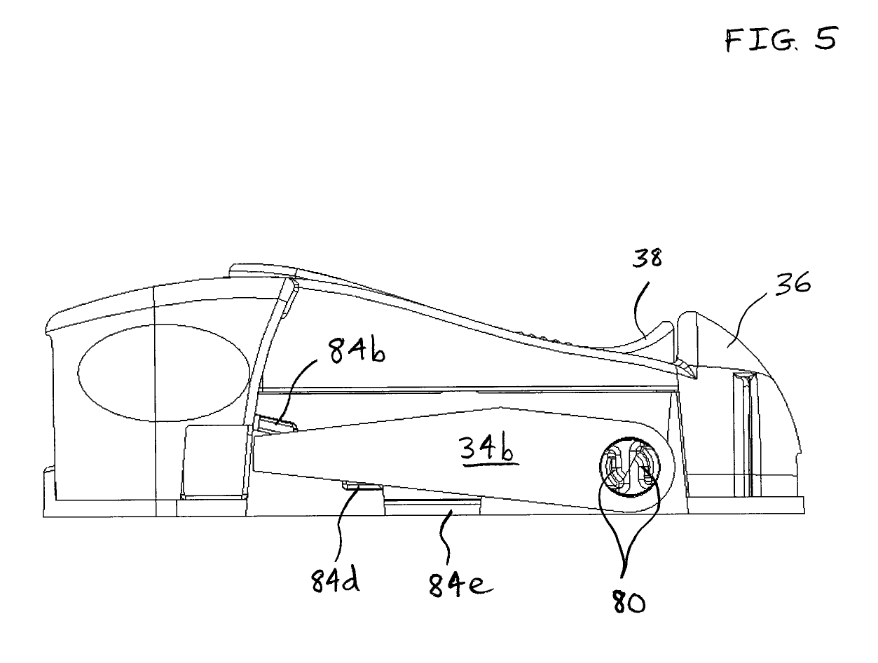

In the second position, latch 82b is received between and latched onto dogs 84c-d, as indicated schematically by dashed line 86b. Adjustment arm 34b is shown in this middle position in FIG. 5.

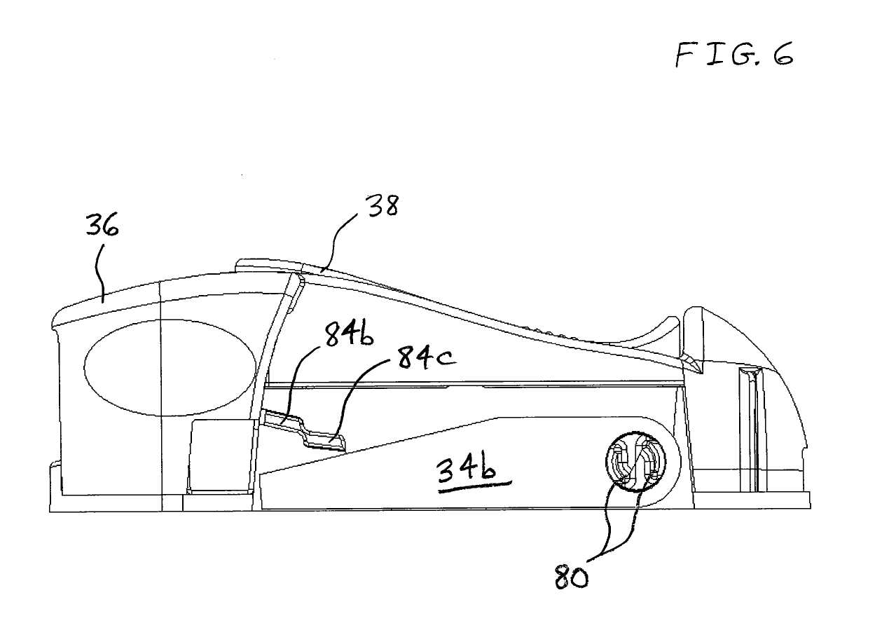

In the third position, latch 82b is received between and latched onto dogs 84d-e, as indicated schematically by dashed line 86c. In this third position, hood 32 is in its lowest position, and hood 32 may be tightest around the user's finger. Adjustment arm 34b is shown in this lowest position in FIG. 6.

Latch 82a and wall 52a may be mirror images of the above-described latch 82b and wall 52b, and thus are not described in detail herein in order to avoid needless repetition. As described above, hood 32 straddles rocker arm 38 such that hood 32 and rocker arm 38 define therebetween an opening sized to snugly receive a user's finger. A size (e.g., a cross-sectional area) of the opening defined between the elastic element and the rocker arm may be adjusted by moving the body of the adjustment arm between the various attachment positions.

In order to replace or swap one adjustable hood assembly for another, the user may use his fingers or a tool to move one or both projections 80 towards the other projection to thereby release an adjustment arm therefrom. In another embodiment, the user can use only his fingers to simply pull the adjustment arm away from wall 52b and the adjustment arm disengages from projections 80. Of course, the same procedure may be used to release the other adjustment arm. The adjustment arms of the new or replacement adjustable hood assembly may then be easily snapped onto projections 80 on both sides of mouse 30. Thus, as described above, the adjustable hood assembly may be swapped with another adjustable hood assembly by using only the user's fingers, and no tools may be required.

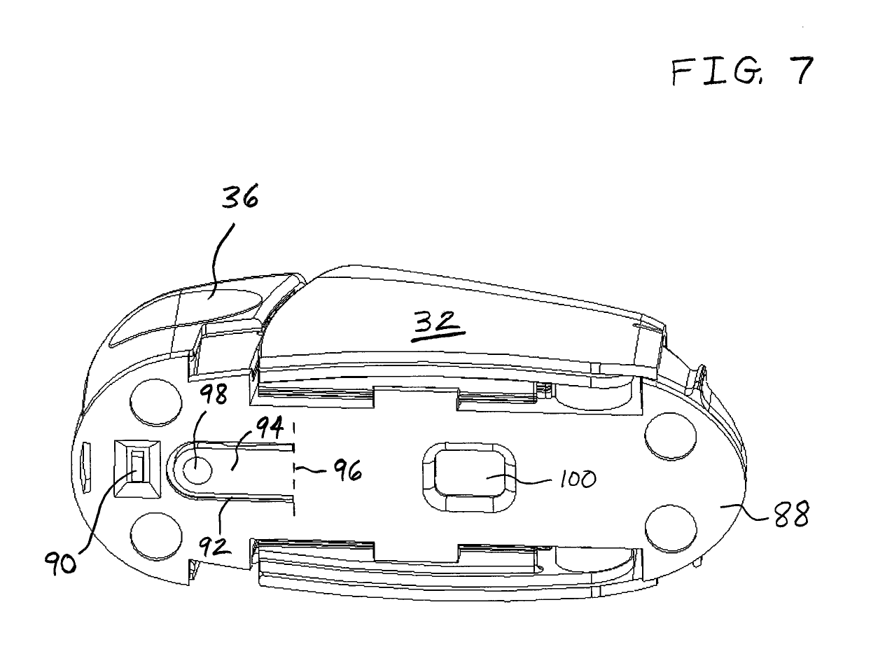

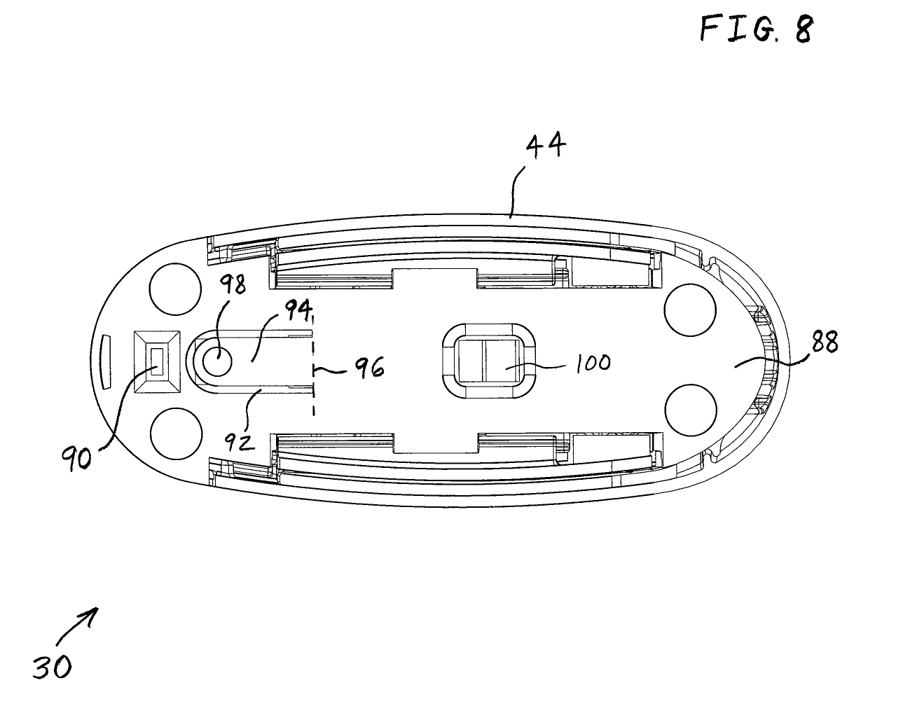

A bottom view of mouse 30 is shown in FIG. 7 with retaining clip 44 removed, and is shown in FIG. 8 with retaining clip 44 attached. A bottom surface 88 of base 42 includes a through hole exposing a pushbutton on/off switch 90 on a bottom surface of circuit board 46.

Bottom surface 88 also includes an arched slot 92 defining a cantilever 94 that is limitedly pivotable about an imaginary axis 96. By pressing on a distal end 98 of cantilever 94, the user can cause distal end 98 to actuate a pushbutton synchronization switch (not shown) on the bottom surface of circuit board 46. Actuation of the synchronization switch may initiate a procedure for wirelessly synchronizing communication with an external device.

Bottom surface 88 also includes a rectangular through slot 100 through which an optical device (not shown) on the bottom of circuit board 46 may detect the degree of movement of mouse 30.

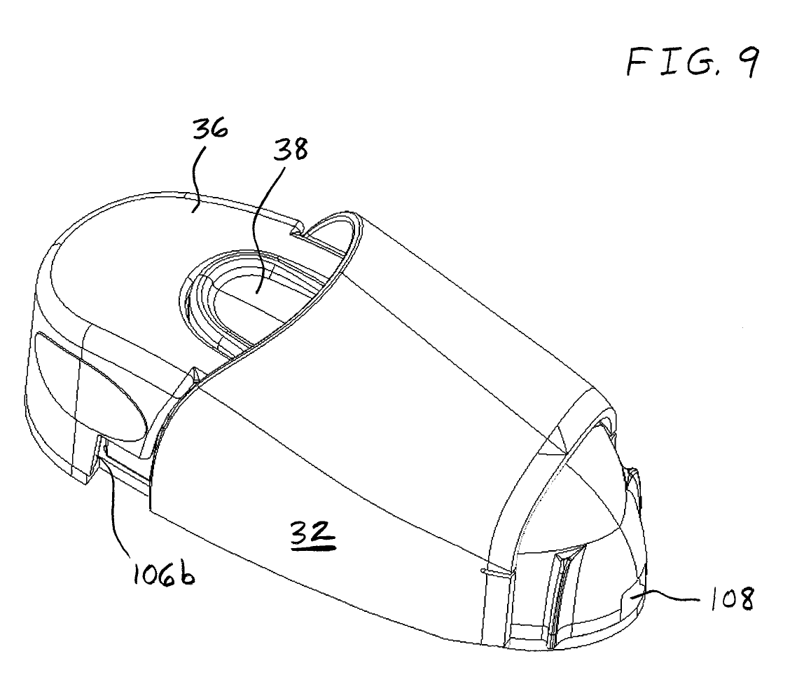

After adjustment arms 34a-b have been set to the desired height position corresponding to the desired level of tightness of hood 32 around a particular finger, retaining clip 44 may be attached to body 36 as the final step of assembly. Two opposite distal ends of clip 44 include offset inserts 102a-b (FIG. 2). At the center of clip 44 is a rectangular projection 104. Body 36 two slots for respectively receiving inserts 102a-b, with only one slot 106b being visible in FIG. 9. Body 36 also includes a rectangular through slot 108 for receiving projection 104.

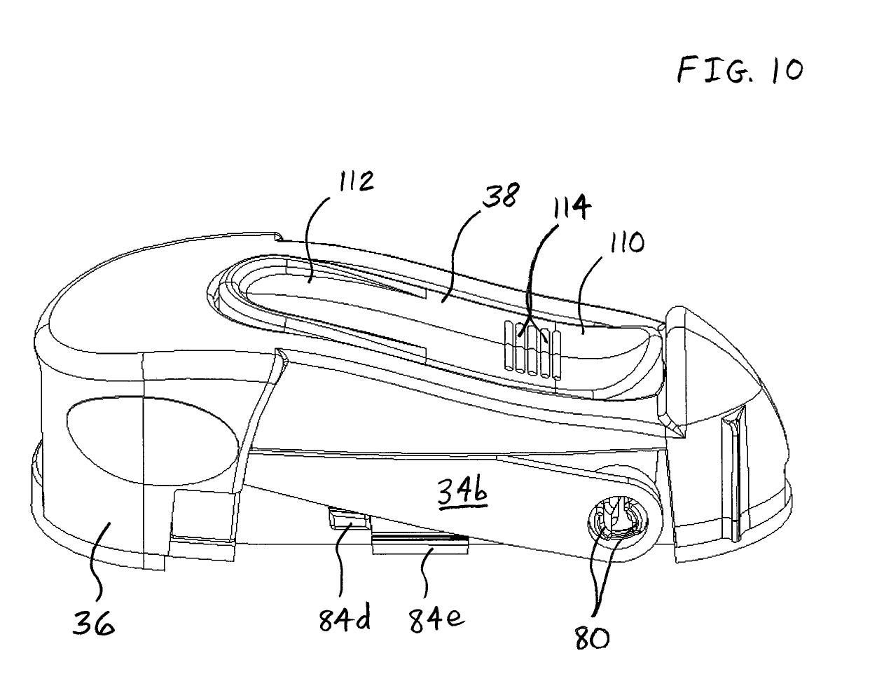

In FIGS. 10-12, hood 32 is removed in order to provide a better view of the position of rocker arm 38, which is the subject of FIGS. 10-12. However, it is to be understood that hood 32 is normally in place when rocker arm 38 is being actuated by a user's finger. FIG. 10 illustrates the position of the rocker arm in an unbiased position, i.e., without any force being applied thereto by a user's finger. As can be seen in FIG. 10 a forward half 110 of rocker arm 38 is disposed lower than a rearward half 112 of rocker arm 38. This orientation of rocker arm 38 may be ergonomically advantageous and comfortable for the user.

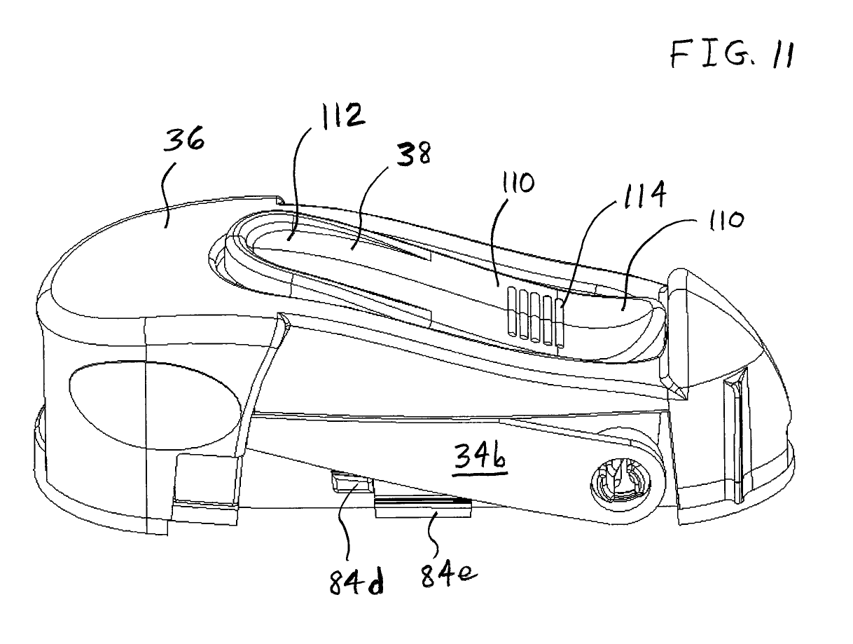

FIG. 11 illustrates the position of rocker arm 38 in a forward biased position. That is, FIG. 11 illustrates the position of the rocker arm when a user's finger is pressing down on a forward half 110 of rocker arm 38. Forward half 110 may have surface texturing in order to increase the friction between forward half 110 and the user's finger, and thereby make it easier for the user to press down on forward half 110. In the specific embodiment shown in the drawings, the surface texturing is in the form of five parallel ribs 114. The user's distal phalanx finger section (i.e., the tip section of the three sections of a finger) may typically be positioned to press down on forward half 110. An upper surface of rocker arm 38 may be curved to match a contour of an inner surface of a human index finger.

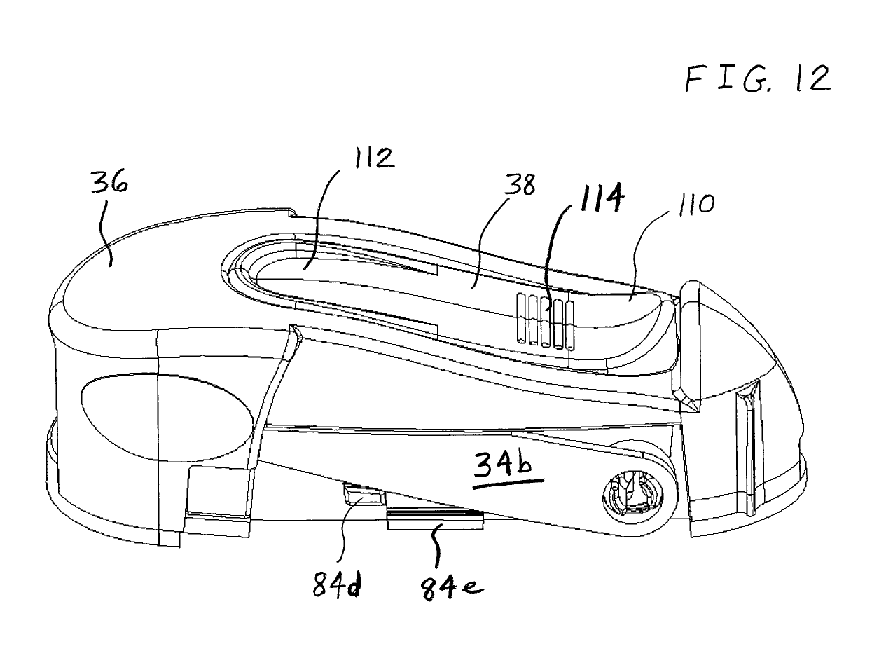

FIG. 12 illustrates the position of rocker arm 38 in a rearward biased position. That is, FIG. 12 illustrates the position of the rocker arm when a user's finger is pressing down on a rearward half 112 of rocker arm 38. The user's middle phalanx finger section and/or proximal phalanx finger section (i.e., the first two sections closest to the palm of the three sections of a finger) may typically be positioned to press down on rearward half 112.

Pressing down on forward half 110 may correspond to pressing down on the left button of a conventional mouse, and pressing down on rearward half 112 may correspond to pressing down on the right button of a conventional mouse. However, it is also possible within the scope of the invention for pressing down on forward half 110 to correspond to pressing down on the right button of a conventional mouse, and for pressing down on rearward half 112 to correspond to pressing down on the left button of a conventional mouse, as this is easily configurable within the inventive mouse.

Although hood 32 has been shown herein as being attached to arms 34a-b, it is also possible within the scope of the invention for a hood to be directly attached to the housing or to the rocker arm.

We claim:

1. A point and click computer device comprising:
first and second pushbutton switches;
an elongate rocker arm having first and second opposite ends; and
a housing containing the switches and including a support supporting a mid-section of the rocker arm between the ends, the rocker arm being pivotable about the support between a first position in which the first end depresses the first pushbutton switch, a second position in which the second end depresses the second pushbutton switch, and an unbiased position in which neither of the switches is depressed.

2. A device according to claim 1, wherein the support of the housing supports an axle of the rocker arm.

3. A device according to claim 1, wherein, when the mouse is resting on a horizontal surface, an upper surface of one of the ends of the rocker arm is disposed above an other of the ends of the rocker arm in the unbiased position.

4. A device according to claim 3, wherein, when the mouse is resting on a horizontal surface, an upper surface of the one end of the rocker arm is disposed above the other end of the rocker arm in each of the first and second positions.

5. A device according to claim 1, further comprising an arch-shaped elastic element straddling the rocker arm and configured to snugly retain a user's finger on an upper surface of the rocker arm.

6. A device according to claim 5, wherein a cross-sectional area of a finger opening defined between the elastic element and the rocker arm is adjustable.

7. A device according to claim 1, wherein an upper surface of the rocker arm is curved to match a contour of an inner surface of a human index finger.

8. A computer mouse comprising:
first and second switches;
an elongate rocker arm having first and second opposite ends;
a housing containing the switches and including a support supporting a mid-section of the rocker arm between the ends, the rocker arm being pivotable about the support between a first position in which the first end actuates the first switch, a second position in which the second end actuates the second switch, and an unbiased position in which neither of the switches is actuated; and
an arch-shaped elastic element having a first end attached to the rocker arm or to the housing and straddling at least a majority of the rocker arm, the elastic element and the rocker arm defining therebetween an opening sized to snugly receive a user's finger.

9. A device according to claim 8, wherein the elastic element is formed of a sheet of stretchable fabric material.

10. A device according to claim 8, wherein a size of the opening is adjustable.

11. A device according to claim 8, further comprising an adjustment arm interconnecting the elastic element and the housing.

12. A device according to claim 11, wherein the adjustment arm is connectable to the housing at a plurality of different positions to thereby adjust a size of the opening.

13. A device according to claim 8, wherein the elastic element includes a second end attached to the rocker arm or to the housing.

14. A device according to claim 8, wherein the elastic element straddles an entirety of the rocker arm.

15. A computer mouse comprising:
first and second switches;
an elongate rocker arm having first and second opposite ends;
a housing including a support supporting the rocker arm between the ends, the rocker arm being pivotable about the support between a first position in which the first end actuates the first switch, a second position in which the second end actuates the second switch, and an unbiased position in which neither of the switches is actuated;
at least one adjustment arm having an end pivotably attached to the housing, the adjustment arm having a body attachable to the housing at each of a plurality of attachment positions, and
an arch-shaped elastic element having an end attached to the body of the adjustment arm such that a size of an opening defined between the elastic element and the rocker arm may be adjusted by moving the body of the adjustment arm between the attachment positions.

16. A device according to claim 15, wherein the at least one adjustment arm comprises two adjustment arms, each of the adjustment arms being disposed on an opposite side of the housing, the end of the elastic element comprising a first end attached to a first said adjustment arm, the elastic element having a second end attached to a second said adjustment arm.

17. A device according to claim 16, wherein each of the adjustment arms is attachable to the housing at each of a respective plurality of attachment positions.

18. A device according to claim 15, wherein the housing includes a plurality of first snap-fit connectors, each of the first snap-fit connectors being disposed at a respective one of the attachment positions, the adjustment arm including a second snap fit connector mateable with each of the first snap-fit connectors.

19. A device according to claim 15, wherein the elastic element is formed of a sheet of stretchable fabric material.

20. A device according to claim 15, wherein the elastic element straddles the rocker arm.
